(19) United States
(12) Patent Application Publication
(10) Pub. No.: US 2007/0082097 A1
(43) Pub. Date: Apr. 12, 2007

(54) Method and apparatus for cooking particulate food material

(76) Inventor: Jose de la Luz Martinez-Montes, Huntington Park, CA (US)

Correspondence Address: Spyros J. Lazaris;Sidley Austin Brown & Wood LLP, Suite 4000, 555 West Fifth Street, Los Angeles, CA, 90013-1010, US

(21) Appl. No.: 11/249,564

(22) Filed: Oct. 12, 2005

(51) Int. Cl. A23B 4/06

(52) U.S. Cl. 426/506

(57) ABSTRACT

An apparatus and method of cooking particulate food material includes circulating particulate food material in a heated cooking solution within a cooking tank. The cooking solution is heated by continuously injecting steam into the cooking tank to cook the particulate solution. Additional cooking solution is added to the cooking tank each time particulate food material is to be added to the cooking tank to replace cooking solution lost after cooked particulate food material has been removed from the cooking tank. It is emphasized that this abstract is provided to comply with the rules requiring an abstract which will allow a searcher or other reader to quickly ascertain the subject matter of the technical disclosure. It is submitted with the understanding that it will not be used to interpret or limit the scope or the meaning of the claims.

### FIELD OF THE INVENTION

The present invention generally relates to the cooking of particulate food materials. Specifically, the present invention relates to an apparatus and method of cooking particulate food material in which a cooking solution is continuously heated and recycled to improve consistency of the cooked product and increase efficiency in the cooking process.

### BACKGROUND OF THE INVENTION

Cooking particulate food materials is well-known in the art. In a batch-type apparatus for cooking particulate food materials, it is also well-known that the flavor and texture of batch-cooked food products preserve well, provided the cooking occurs in the food material's own liquid. Although widely employed, batch cooling systems usually do not offer tight quality control of the final product, employ several time consuming steps to achieve their purpose, are energy inefficient during warm up and cool down cycles, and detection of faults in the cooking parameters are not analyzed until the end cycle of the batch. Such issues result in increased costs which may lead to higher consumer prices.

Another cooking method continuously cooks food by means of a screw conveyor cooking tube that includes a tube parallel to a cooking tube between an input end and an exit end of the cooking tube. Water is heated in the parallel tube by means of steam spray nozzles, which assist in recirculation and propelling of the water with the help of an auger. The cooking process occurs at atmospheric pressure, which does not result in decreasing the cooking time or increasing cooking temperatures above the atmospheric boiling point.

Another apparatus cooks particulate food materials, such as cereal grains, in a continuous grain cooker that employs temperatures between 240°-300° F. in a liquid mixture. However, rapid vaporization of hot liquid from within the food material caused by its sudden depressurization at the exit of the cooking stage, known as flashing, occurs with this type of apparatus.

Another continuous cooking apparatus includes a cooling process stage to avoid flashing of the products. Cooking of food materials occurs in several moving carts, each transported through a cooking tunnel through locked inlet, processing, and outlet stages. Each cart is loaded with the food material in a preheating stage and moved into a cooking stage where the cooking liquid is added. After cooking, the material from the cooking tunnel advances to a cooling stage of the machine, where cold liquid is added. While this machine addresses cooking foods in their own liquid, a large space is required to cook particulate food materials and the machine employs bulky cooking carts.

### SUMMARY OF THE INVENTION

In one embodiment of the present invention, a method of cooking particulate food material includes circulating particulate food material in a heated cooking solution within a cooking tank, the cooking solution heated by continuously injecting superheated steam into the cooking tank to cook the particulate solution. Additional cooking solution is added to the cooking tank each time particulate food material is to be added to the cooking tank to replace cooking solution lost after cooked particulate food material has been removed from the cooking tank.

In another embodiment, an apparatus for cooking particulate food material includes a cooking tank having a first input section through which particulate food material enters the cooking tank from an input hopper and a second input section through which cooking solution enters the cooking tank from a cooking solution source. A steam injection valve through which the cooking solution is continuously heated to cook the particulate food material in the cooking tank. The apparatus also includes a draining tube positioned at an output section of the cooking tank, the cooked particulate food material and at least some of the cooking solution exiting the cooking tank through the draining tube, and a cooling tank coupled to the draining tube for receiving cooked particulate food material, the cooling tank having a jacket disposed on an outside portion of the cooling tank, the cooling jacket being capable of receiving cooled water to cool cooked particulate food material in the cooling tank.

In another embodiment, a method of cooking particulate food material comprises inserting a cooking solution into a cooking tank, continuously injecting steam into the cooking tank to heat the cooking solution to a desired level, and introducing particulate food material into the cooking tank and cooking the particular food material in the heated cooking solution. The method further includes draining the particulate food material into a cooling tank after the particulate food material is cooked, wherein at least a portion of the cooking solution is drained out of the cooking tank with the cooked particulate food material, filling a cooling jacket substantially surrounding the cooling tank with cooled water, the cooled water being recycled from the cooking solution drained out of the cooking tank, and cooling the cooked particulate food material in the cooling tank and ejecting the cooled and cooked particulate food material into a cooling hopper.

The foregoing and other aspects of the present invention will be apparent from the following detailed description of the embodiments, which makes reference to the several figures of the drawings as listed below.

### BRIEF DESCRIPTION OF THE DRAWINGS

FIG. 1 is a perspective view of a cooking apparatus according to the present invention;

FIG. 2 is a close-up internal view of an input portion of a cooking tank in a cooking apparatus according to the present invention; and

FIG. 3 is a close-up view of an input portion of a cooling tank and showing separation of particulate food material from excess cooking solution in a cooking apparatus according to the present invention.

### DETAILED DESCRIPTION OF THE EMBODIMENTS

In the following description of the present invention reference is made to the accompanying drawings which form a part thereof, and in which is shown, by way of illustration, exemplary embodiments illustrating the principles of the present invention and how it may be practiced. It is to be understood that other embodiments may be utilized to practice the present invention and structural and functional changes may be made thereto without departing from the scope of the present invention.

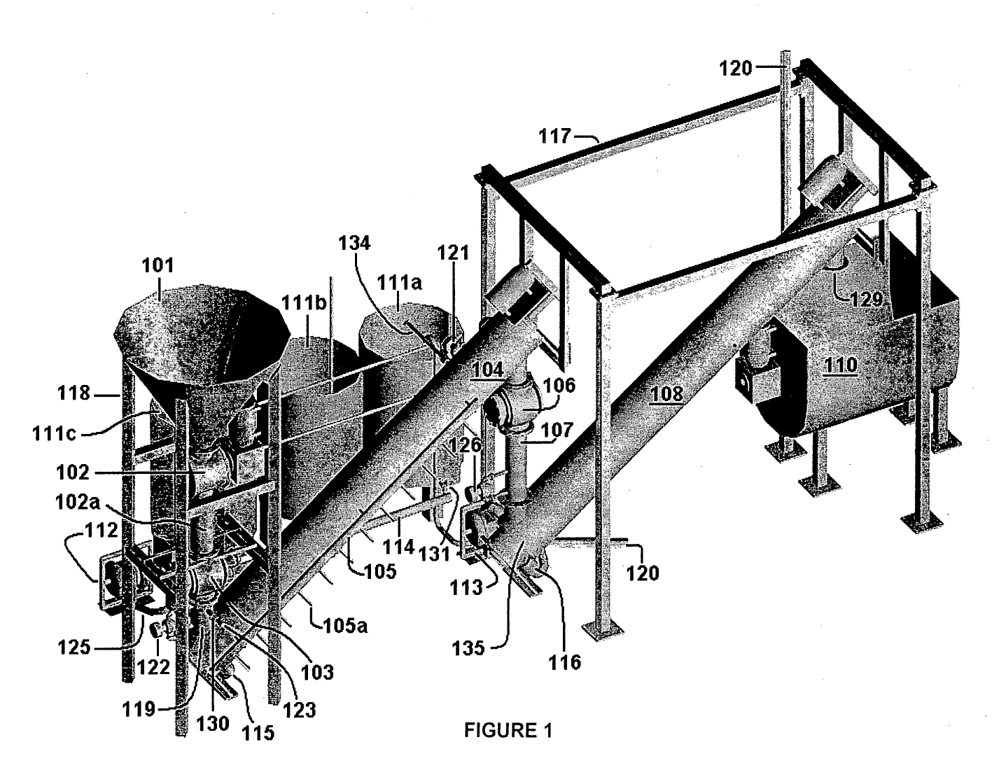

FIG. 1 shows a perspective view of an apparatus 100 for cooking particulate food material according to one embodiment of the present invention. The apparatus 100 includes an input hopper 101 wherein particulate food material is held prior to entry into feeding device 102. Particulate food material enters from the input hopper 101 downward into the feeding device 102. The input hopper 101 may be a device of any size or shape capable of holding any amount of particulate food material for deposit into the feeding device 102, and the feeding device 102 may also be a device of any size or shape that is capable of receiving particulate food material from the input hopper 101. In one embodiment, the feeding device is a rotatable volumetric feeding valve. This valve includes a cylindrical close-end shell, which in combination with a driven internal rotor defines moving pockets which continuously advance volumetric amounts of particulate food material from the input hopper 101. In another embodiment, feeding device 102 includes a transportation auger mechanically disposed to continuously feed the particulate food material downward.

A lower flange connects the feeding device 102 to a round flanged pipe 102aof enough diameter and length to accumulate enough particulate food material fed intermittently from the feeding device 102. In one embodiment, the pipe 102a may be an accumulation pipe of enough diameter and length to hold particulate food material from the feeding device 102. After enough material accumulates in pipe 102a, a gate input device 103 receives and feeds the material into a cooking tank 104. In one embodiment of this invention, the gate input device 103 is a modified multi-way input ball valve 103 connected to the lower flange of pipe 102a. The gate input device 103 accepts accumulated particulate food material on every half of a continuous rotation. In another embodiment the multi-way valve input ball valve 103 has one or more adapted hemispherical caps, or plugs, attached to one or more of its extreme ends to form a rotating spherical cup. The rotation axis of the ball valve 103 is perpendicular to the normal of the bottom surface of the spherical cup to allow enough volume of the accumulated particulate food material from pipe 102a to avoid mechanical abrasion thereto. Input hopper 101, feeding valve 102, pipe 102a, and ball valve 103 attach mechanically to a steel frame 118.

In another embodiment of the present invention, the input ball valve 103 may include two standard one-way ball valves or two rotating vane valves connected in series and working in an alternate close-open, push-pull operation. In this embodiment, the continuous rotation of a valve 103 induces the particulate food material to drop, via gravity, into the cooking tank 104 through an input pipe 119 during the other half of the rotation cycle.

The cooking tank 104 may be positioned horizontally or at an angle. If positioned at an angle, the inclination of the cooking tank 104 may be any at angle of any degree from the horizontal plane. The inclination angle of the cooking tank 104 is selected so as not to allow too small of an amount of a cooking solution to exist in the cooking tank 104 and not to lower the transport capacity per unit of time of cooked particulate food material. In one embodiment, the inclination of the cooking tank 104 is between 10 to 45 degrees. In another embodiment, the cooking tank 104 has an inclination angle from the horizontal plane of 35 degrees. A steel frame 117 that mechanically holds the output extreme of the cooking tank 104 to a sufficient height above the ground level supports the cooking tank 104 at a selected inclination angle.

The inclined cooking tank 104 is kept continuously filled with an appropriate amount of cooking solution up to a predetermined exit level set by a level sensor 121 located at a distance below an output end of the cooking tank 104, and by means of fresh cooking solution input 125 and a pump 112. Additionally, the level sensor 121 and pump 112 are automatically controlled by any mechanical, electrical, electronic, magnetic, or optical means known to those skilled in the art. The input pipe 119 is of enough volume so as to permit the cooking solution input level to be maintained at a predetermined level below the valve 103. The cooking solution level controls itself automatically by any mechanical, electrical, electronic magnetic, or optical means known to those skilled in the art, by the concerted action of sensor 122 and a pressurized flux of steam injected at input pipe 123.

Cooking solution is provided to the apparatus 101 from cooking solution tanks 111aand 111band from recycled cooking solution tank 111c. At the beginning of a cooking process using apparatus 101, tanks 111aand 111bare filled in advance with cooking solution. Tank 111cis initially left empty, but receives recycled cooking solution once the cooking process starts.

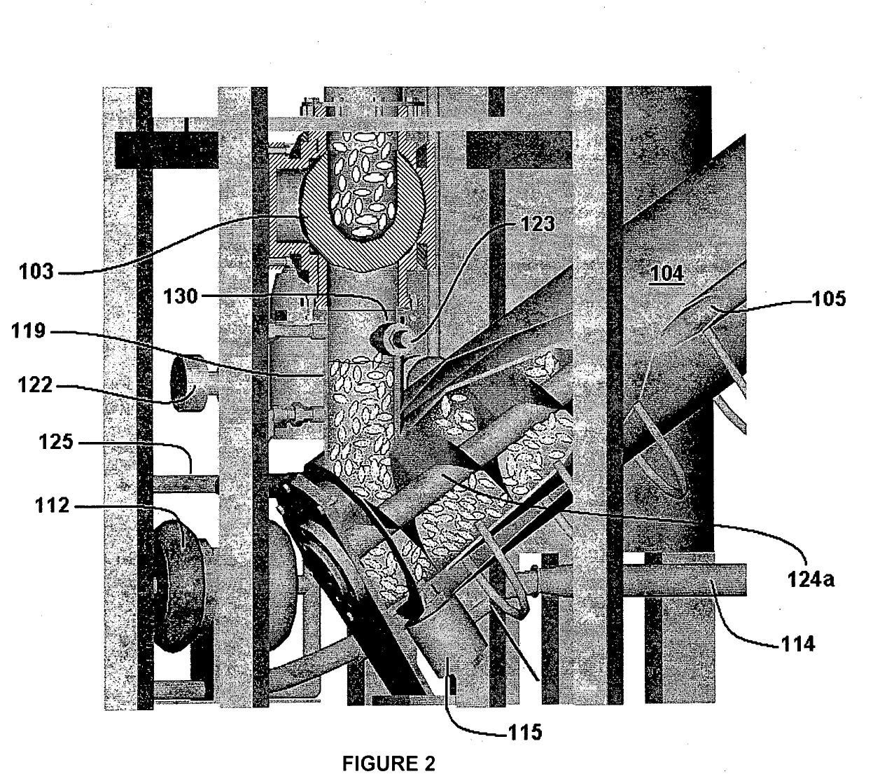

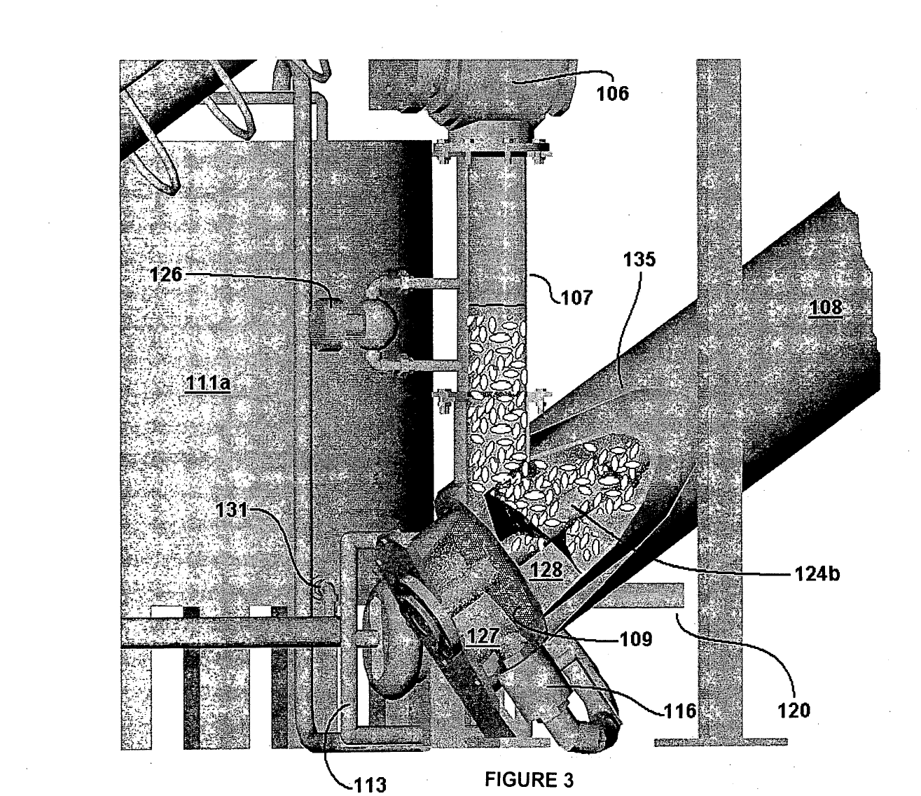

Use of cooking solution from tanks 111a, 111band 11cis by ratio of fresh cooking solution to recycled cooking solution. In one embodiment, the ratio is 3:1. The selection of tanks 111a, 111band 111cfrom which cooking solution is provided to the apparatus 101 is automatically controlled. When filling, valves for both source tanks (either 111aor 111bfor fresh cooking solution, and 111cfor recycled cooking solution) are open simulateously, The control of the tanks 111aor 111balso changes the source tank automatically if one of tanks 111aor 111bis empty. When empty, tanks 111aand 111bfill with water and lime is added later after the tank is full. FIG. 2 shows the pressurized steam input in connector pipe 123, which serves a dual purpose during cooking as the heat input of the cooking system and to maintain the cooking solution level below a predetermined distance from the valve 103 by gas pressure. Transport of the particulate food material along the length of the cooking tank 104 occur by means of an auger 124a. Referring back to FIG. 1, as the particulate material approaches the exit portion of the cooking tank 104, the cooked particulate food material surpasses the cooking solution level set by sensor 121, drains off any excess cooking solution, and drops by gravity into a multi-way, modified exit ball valve 106. Similarly to input valve 103, in a one embodiment of the present invention, valve 106 has one or more adapted hemispherical caps, or plugs, attached to one or more of its extreme ends to form a rotating spherical cup. The rotation axis of the exit ball valve 106 is perpendicular to the normal of the bottom surface of the spherical cup to allow enough volume of the cooked particulate food material from pipe 107 to avoid mechanical abrasion thereto. As shown in FIG. 3, the continuous rotation of the exit valve 106 allows receiving the cooked particulate food material every half of the rotation cycle, and during the other rotation cycle allows the cooked particulate food material down into the inclined cooling tank 108. The angle of inclination is selected by choosing the best such angle so as not to allow cooking solution to enter the cooling tank 108 and not to lower the transport capacity per unit of time of cooled particulate food material. In one embodiment, the inclined cooling tank 108 has an angle of inclination from the horizontal plane of 35 degrees. The inclined cooling tank 108 is supported by steel frame 117 that mechanically holds an output end of the cooling tank 108 to a sufficient height above ground level and adapts the cooling tank 108 to an angle of inclination.

Output ball valve 106 may be of any configuration which allows particulate food material to move into the cooling tank 108, such as two standard one-way ball valves or two rotating vane valves connected in series and working in an alternate close-open, push-pull operation. During the exit of particulate food material from valve 106, the particulate food material may carry out any quantity of excess cooking solution down into pipe 107. In continuous operation, the pipe 107 maintains a specific cooking solution level by means of level sensor 126. The sensor is controlled automatically by any mechanical, electrical, electronic, magnetically, ultrasound or optical means known to those skilled in the art. Any amount of cooking solution which surpasses the cooking solution level causes pump 113 to pass the excess cooking solution to recycle tank 111a. The excess cooking solution in pipe 107 and the cooked particulate food material in cooling tank 108 cool down to a temperature below that of the boiling point of the cooking solution employed. The cooking solution is cooled by injection of pressurized cool air into the cooked particulate food material flowing inside the cooling tank 108, recirculation of chilled water or fluid around the cooling tank 108, or by any other means known to those skilled in the art. In one embodiment, cooling of cooked particulate food material is by means of a cooling jacket 135 positioned lengthwise around the cooling tank 108 through which chilled water flows from fluid pipes 120. Separation of cooked particulate food material and cooking solution occurs at the bottom of the cooling tank 108. A circular mesh 109 of radial dimension equal to an internal radius of cooling tank 108 divides the cooling tank 108 in two internal areas, one area 127 for collection of cooled cooking solution, and a second area 128 for collection of cooked particulate food material. Recycle pump 113 forces recycled cooking solution to exit area 127 at recycle valve 116. Auger 124b transports cooked particulate food material in area 128 to the exit portion 129 of the cooling tank 108, where the cooked and cooled particulate food material then drops into output hopper 110. Recycled, cooled cooking solution is then transported to recycle tank 111a.

In one embodiment of the present invention, called steam cooking control, the cooking tank 104 fills with cooking solution from recycle tank 111a, or cooking solution storage tanks 111band/or 111c, to the level set by sensor 121. At the same time augers 124a 124b in cooking tank 104 and cooling tank 108 start rotating by means of any mechanical power transmission known in the art to continuously agitate continuously the cooking solution in the cooking tank 104. The cooking solution is heated by injection of steam to the cooking tank 104 through a steam distribution muffler 105 and a series of steam nozzles 105a, distributed along the length of the body of the cooking tank 104, and connected by means of flexible steam hoses to the bottom side of the cooking tank 104. The temperature of the cooking solution is monitored by a sensor, which may be a thermocouple of any type of sensor known in the art. Before reaching the cooking temperature, the steam distribution muffler 105 shuts off, and a set temperature is reached, and controlled, by an automated flux control of pressurized steam entering the cooking tank 104 by means of a flow control valve 130. Steam control is automatically monitored by any mechanical, electrical, electronic magnetically, ultrasound, optical or any other means known to those skilled in the art. The particulate food material is then released from the input hopper 101 by valves 102 and 103. Injection of the cooking solution required for the cooking process is determined by continuously sensing the liquid level changes during the exit of the cooked particulate food material from the cooking tank 104. The cooking solution injected into the cooking tank 104 is made of a mixture of fresh cooking solution contained in tanks 111bor 111c, and recycled cooking solution stored in recycle tank 111a. Determination and calculation of the appropriate amount of cooking solution mixture for a specific particulate food material is by type of particulate food material to be cooked and with consideration to avoid saturation of dissolved solids, and is set during operation by the open dwell time of either valves 131,132, or 133 during an injection cycle. Steam-cooking control allows continuously cooking the particulate food material below and above the boiling temperature of the cooking solution.

In another embodiment of the present invention, called water cooking control, the cooking tank 104 fills with cooking solution from recycle tank 111a, or cooking solution storage tanks 111band/or 111c, to the level set by sensor 121. At the same time augers 124a 124b in cooking tank 104 and cooling tank 108 start rotating by means of any mechanical power transmission known in the art to continuously agitate continuously the cooking solution in the cooking tank 104. The cooking solution is heated by injection of steam to the cooking tank 104 through a steam distribution muffler 105 and a series of steam nozzles 105a, distributed along the length of the body of the cooking tank 104, and connected by means of flexible steam hoses to the bottom side of the cooking tank 104. Before reaching the cooking temperature, the steam distribution muffler 105 shuts off, and a set temperature is reached, and steam input valve 130 is turned on continuously. Because the addition or removal of cooking solution alters the temperature, an automatically-controlled temperature control device controls the amount of cooking solution entering the cooking tank 104 at input section 125 and the amount of cooking solution exiting the cooking tank 104 at output section 134. The cooking solution injected into the cooking tank 104 is made of a mixture of fresh cooking solution contained in tanks 111bor 111c, and recycled cooking solution stored in recycle tank 111a. Determination and calculation of the appropriate amount of cooking solution mixture for a specific particulate food material is by type of particulate food material to cook and with consideration to avoid saturation of dissolved solids, and is set during operation by the open dwell time of either valves 131,132, or 133 during an injection cycle. Water cooking control therefore allows continuous cooking of the particulate food material below and above the boiling temperature of the cooking solution.

The type of particulate food material to be cooked may include corn, rice, grains, beans, or any other type for which quick, high-temperature continuous cooking is desired.

Additional embodiments for various components of the present invention are now described for the apparatus 100 continuously cooking particulate food materials. The inlet and exit gate valve 103 of the apparatus 100 may include a multi-way ball valve 103. The main body of each valve 103 includes a full-bore rotating ball, in which one or more hemispherical cap covers attach in one or more of the extreme openings. The hemispherical caps and the multi-way ball valve 103 form a cylindrical hollow seal-tight container with one open extreme, the additional extremes sealed to form a rotating spherical cup. The rotation axis of the modified ball is perpendicular to the normal of the bottom surface and crosses the center of the spherical cup. A transmission mechanism is included to rotate the spherical cup inside of the main body. The cylindrical hollow container of the spherical cup has enough volume to accept particulate food material every half of its rotation cycle, and the other half of its rotation cycle allows the particulate food material to drop into the next cooking or cooling stage. The valve body includes a mechanism to which a pair of high temperature seal rings can be affixed, each one of the seal rings attached to a recessed seat located inside the main body of the gate valve 103 and aligned to the input and the output ports. The seal rings form a superficial and tight contact between the recessed seats of the main body and the surface of the rotating spherical cup during the complete rotation cycle. The purpose of the seal rings is to seal any steam or cooking solution leak during rotation of the spherical cup and to act as low friction seats for the rotating spherical cup. The valve body includes means of releasing any excess steam pressure or cooking solution leak during each rotating cycle of the spherical cup towards a solution-recycling tank.

The cooking tank 104 of the apparatus may be a cylindrical pipe of enough diameter and length to hold enough cooking solution and particulate food material. The cooking tank 104 may be mechanically positioned at some inclined angle between 10 and 45 degrees from horizontal to facilitate transportation of particulate food material to drain off any excess cooking solution before exiting the cooking tank 104. The cylindrical pipe includes two cover lids positioned at opposite ends to seal against any steam pressure or cooking solution leak, the two cover lids including a means of supporting mechanical movement of particulate food material, such as an auger or continuous transport band. The cylindrical pipe also includes a pipe port for input of particulate food material, which is positioned vertically in the input extreme, and a pipe port for exit of particulate food material, which is positioned vertically at the other output extreme. The cylindrical pipe also include several input and output pipe ports of smaller diameters to allow input or exit of cooking solution, input or exit of pressurized steam, and attachment of temperature and liquid level sensors. The pipe ports may be positioned along the bottom, along the top and sidewise across the length of the cylindrical pipe. The cooking tank 104 also includes any mechanical means known in the art to promote the mechanical movement and transport of particulate food material along the length of the cooking tank 104 by the auger or continuous transport band. The cooling tank 108 of the apparatus may also include a cylindrical pipe of enough diameter and length to hold enough cooled cooking solution and cooled particulate food material. The cooling tank 108 may also be mechanically positioned at some inclined angle between 10 and 45 degrees from the horizontal to drain off any excess cooled cooking solution before cooked and cooled particulate food material exits the cooling tank 108. The cylindrical pipe includes two cover lids positioned at opposite ends to seal against any steam pressure leak or cooking solution leak. The cover lids include means of supporting mechanical movement of particulate food material, such as an auger or continuous transport band. The cylindrical pipe also includes an input pipe port for input of particulate food material that is positioned vertically in the input extreme and of sufficient length to hold any quantity of cooled cooking solution. Also included is an exit pipe port for exit of particulate food material that is positioned vertically at the other output extreme. The cylindrical pipe also includes a series of input pipes that may be distributed along the side of the total length of the cooling tank 108 for the input of cool air. The cooling tank 108 also includes a cooling jacket 135 attached around the total length of the cylindrical pipe to allow chilled water or liquid to recirculate through the apparatus to cool the particulate food material below the boiling point of the cooking solution. Injection of cool air may be performed by any cool air injection device known to those skilled in the art, such as a Hilsh (vortex) tube. The circulation of said chilled water or liquid occurs by any external beat exchanger or water-cooling device known to those skilled in the art. The cylindrical pipe additionally includes several input and output pipe ports of smaller diameters to allow the input or exit of cooking solution, the input or exit of pressurized steam, and the attachment of temperature and liquid level sensors. All of these pipe ports may be positioned along the bottom, the top or across the length of the cylindrical pipe. The cooling tank 108 includes also any mechanical means known in the art to promote the mechanical movement and transport of particulate food material along the length of the cooling tank 108, such as an auger or continuous transport band.

It is to be understood that other embodiments may be utilized and structural and functional changes may be made without departing from the scope,of the present invention. The foregoing descriptions of embodiments of the invention have been presented for the purposes of illustration and description. It is not intended to be exhaustive or to limit the invention to the precise forms disclosed. Accordingly, many modifications and variations are possible in light of the above teachings. For example, the cooling jacket 135 may be made of any material capable of containing chilled liquid for cooling the cooling tank 108 and the particulate food material. The chilled liquid may be fresh water or any other liquid capable of filling the cooling jacket and being chilled to cool the cooling tank 108. The cooling jacket 135 may itself be cooled by an external cooling device coupled to the apparatus 100 separately from the chilled liquid. It is therefore intended that the scope of the invention be limited not by this detailed description.

1. A method of cooking particulate food material comprising:
circulating particulate food material in a heated cooking solution within a cooking tank, the cooking solution heated by continuously injecting superheated steam into the cooking tank to cook the particulate solution, wherein additional cooking solution is added to the cooking tank each time particulate food material is to be added to the cooking tank to replace cooking solution lost after cooked particulate food material has been removed from the cooking tank.

2. The method of claim 1, further comprising positioning the cooking tank at an angle, the cooking tank having an auger disposed on an inside portion of the cooking tank to circulate the particulate food material through the cooking tank to a drain positioned at one end of the cooking tank.

3. The method of claim 1, further comprising filtering and removing waste left in the cooking solution out of the cooking tank after cooking the particulate food material.

4. The method of claim 1, further comprising draining the particulate food material from the cooking tank into a cooling tank.

5. The method of claim 4, further comprising draining excess cooking solution from the cooking tank and from the cooling tank.

6. The method of claim 4, further comprising cooling the cooling tank by circulating cooled water through a cooling jacket disposed around an outside of the cooling tank to cool the cooked particulate food material.

7. The method of claim 5, further comprising recycling the excess cooking and storing the excess cooking solution in at least one recycle tank.

8. The method of claim 5, further comprising cooling the cooling jacket disposed around the cooling tank to cool the cooked particulate food material.

9. The method of claim 1, further comprising regulating the amount of cooking solution in the cooking tank to prevent particulate food material from being overcooked.

10. An apparatus for cooking particulate food material comprising:
a cooking tank having a first input section through which particulate food material enters the cooking tank from an input hopper and a second input section through which cooking solution enters the cooking tank from a cooking solution source;
a steam injection valve through which the cooking solution is continuously heated to cook the particulate food material in the cooking tank;
a draining tube positioned at an output section of the cooking tank, the cooked particulate food material and at least some of the cooking solution exiting the cooking tank through the draining tube; and
a cooling tank coupled to the draining tube for receiving cooked particulate food material, the cooling tank having a cooling jacket disposed on an outside portion of the cooling tank, the cooling jacket being capable of receiving cooled water to cool cooked particulate food material in the cooling tank.

11. The apparatus of claim 10, further comprising an output hopper into which cooled, cooked particulate food material is deposited from the cooling tank.

12. The apparatus of claim 10, further comprising a recycling system for removing excess cooking solution from the particulate food material drained from the cooking tank and storing the excess cooking solution in at least one storage tank.

13. The apparatus of claim 10, wherein the cooling jacket is chilled to cool the cooked particulate food material in the cooling tank.

14. The apparatus of claim 10, further comprising a filter positioned within the cooking tank, the filter for capturing waste left in the cooking solution tank after cooking the particulate food material.

15. The apparatus of claim 10, wherein the amount of cooking solution in the cooking tank is regulated to prevent particulate food material from being overcooked.

16. The apparatus of claim 10, further comprising an inlet valve positioned at an end of the input hopper to regulate the amount of particulate food material entering the cooking tank.

17. The apparatus of claim 10, further comprising an auger positioned within the cooking tank to continuously circulate particulate food material within the cooking tank and to force cooked particulate food material out of the cooking tank and into the draining tube after the particulate food material has been cooked.

18. The apparatus of claim 17, wherein the cooking tank is positioned at an angle to allow a substantial amount of the cooking solution to remain in the cooking tank as cooked particulate food material is removed from the cooking tank into a draining tube coupled to an end of the cooking tank, the auger forcing the cooked particulate food material to the end of the cooking tank for removal into the draining tube.

19. The apparatus of claim 18, wherein the angle is between 10 and 45 degrees from a ground level.

20. The apparatus of claim 10, wherein the cooking solution is a mixture of water and lime.

21. The apparatus of claim 10, wherein the particulate food material is corn.

22. The apparatus of claim 10, wherein the particulate food material is any type of food.

23. A method of cooking particulate food material comprising:
inserting a cooking solution into a cooking tank;
continuously injecting steam into the cooking tank to heat the cooking solution to a desired level;
introducing particulate food material into the cooking tank and cooking the particular food material in the heated cooking solution;
draining the particulate food material into a cooling tank after the particulate food material is cooked, wherein at least a portion of the cooking solution is drained out of the cooking tank with the cooked particulate food material;
filling a cooling jacket substantially surrounding the cooling tank with cooled water; and
cooling the cooked particulate food material in the cooling tank-and ejecting the cooled and cooked particulate food material into a cooling hopper.

24. The method of claim 23, further comprising positioning the cooking tank at an angle to allow a substantial amount of the cooking solution to remain in the cooking tank as cooked particulate food material is removed from the cooking tank into a draining tube coupled to an end of the cooking tank.

25. The apparatus of claim 24, further comprising continuously circulating particulate food material within the cooking tank, wherein an auger positioned within the cooking tank moves the particulate food material within the cooling tank and forces cooked particulate food material out of the cooking tank and into the draining tube after the particulate food material has been cooked.

26. The apparatus of claim 23, where excess cooking solution drained out of the cooking tank is stored for reuse in at least one storage tank.

27. The apparatus of claim 23, wherein the cooling jacket is chilled to cool the cooked particulate food material in the cooling tank.

28. The method of claim 25, further comprising filtering and removing waste left in the cooking solution out of the cooking tank after cooking the particulate food material.

29. The method of claim 23, further comprising regulating the amount of cooking solution in the cooking tank to prevent particulate food material from being overcooked.
